(19) United States
(12) Patent Application Publication
(10) Pub. No.: US 2012/0296733 A1
(43) Pub. Date: Nov. 22, 2012

(54) METHOD TO MONITOR AND REWARD THE USE OF A WEBSITE ACTIVITY BASED ON A REWARD SYSTEM

(76) Inventors: ELEMER PIROS, Jersey City, NJ (US); Andrea Honis, Jersey City, NJ (US)

(21) Appl. No.: 13/112,258

(22) Filed: May 20, 2011

(51) Int. Cl. G06Q 30/00; G06Q 10/00

(52) U.S. Cl. 705/14.39; 705/14.73; 705/1.1

(57) ABSTRACT

A method for monitoring and rewarding website activities based on a point reward system. The method for monitoring and rewarding a website activity includes the steps of creating a plurality of webpage links on the website, allocating a point value to each webpage link, tallying point values by navigating through at least one of the webpage links, the tallying is performed by a computer-readable program.

### BACKGROUND OF THE INVENTION

The present invention generally relates to a method for rewarding the use of website activities. More particularly, the present invention relates to a method for rewarding the use of website activities based on a point reward system.

While visiting a website, publishers attempt to direct users to particular features by highlighting or positioning content prominently. It is common to place on the webpage pictures and videos to further direct the user to click on the particular features. Unfortunately, the advertising methods of the prior art do not provide an incentive to the user for visiting content beyond the homepage, or to participate in social activities, such as discussion forums, or to write opinions on the content of the website. Furthermore, the methods of the prior art do not guide and encourage users to visit preferred features in a graded, differentiated manner.

As can be seen, there is a need for a method for providing the user with an incentive for visiting content beyond a homepage.

### SUMMARY OF THE INVENTION

In one aspect of the present invention, a method for monitoring and rewarding a website activity includes the steps of creating a plurality of webpage links on the website, allocating a point value to each webpage link, tallying point values by navigating through at least one of the webpage links, the tallying is performed by a computer-readable program.

These and other features, aspects and advantages of the present invention will become better understood with reference to the following drawings, description and claims.

### BRIEF DESCRIPTION OF THE DRAWINGS

FIG. 1 illustrates a flowchart of the steps of a method for monitoring and rewarding a website activity based on a point reward system according to an exemplary embodiment of the present invention; and

FIG. 2 illustrates a flowchart which is a continuation of the flowchart of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a method for monitoring and rewarding website activities based on a point reward system.

The term “point values” as used herein refers to any standard system that may allow the user to make a count for getting a score.

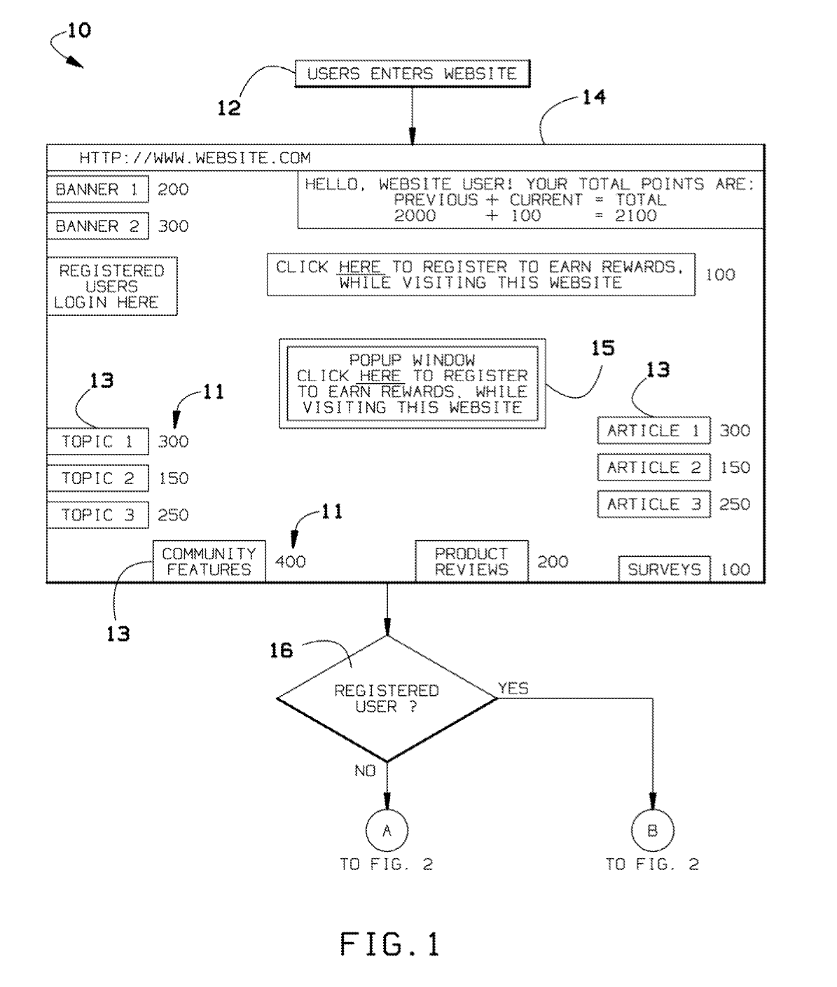

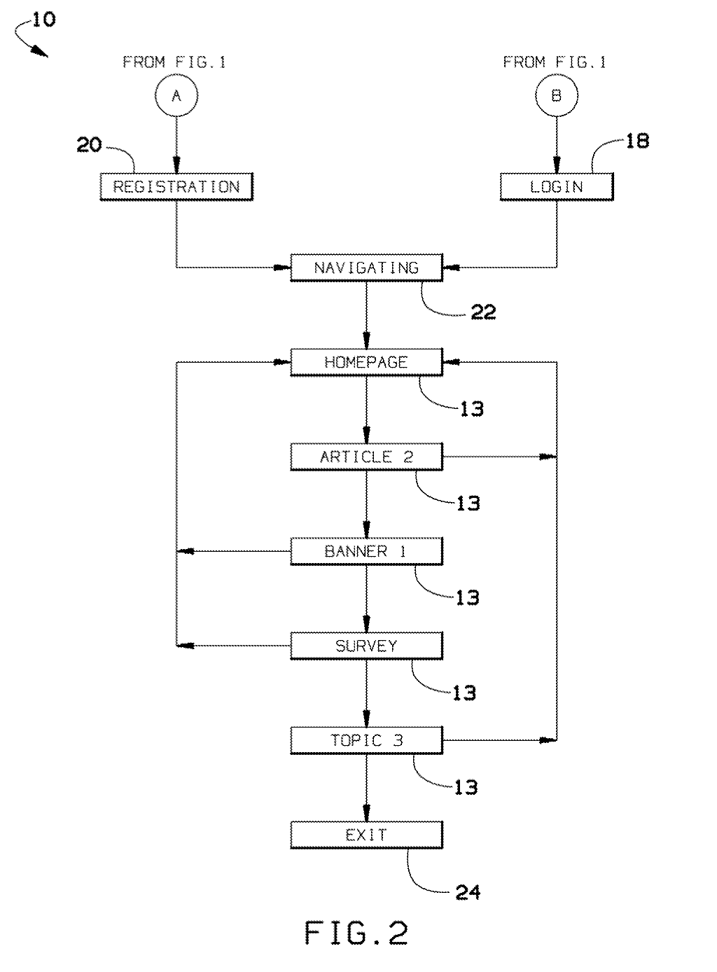

FIGS. 1-2 illustrate a flowchart of the steps of a method 10 for monitoring and rewarding use of a website activity based on a point reward system according to an exemplary embodiment of the present invention. The method 10 may allocate a point value 11 to every visited webpage link 13 associated with a website 14. The method 10 may encourage the user to collect as many point values 11 during a given period, in order to receive a reward.

In step 12, the user may enter the website 14. As soon as the user enters the website 14, a pop-up window or a prominent text 15 may advise the user to register and to navigate the website as a registered user.

In step 16, the user may select to either log in 18 or register 20. If the user already has an account, the user may select logging in 18. If the user does not have an account, the user may select registering 20.

In step 18, the user may enter his/her username and password to enter the website in order to collect point values 11. Once the user is logged in, the website may pop up a screen containing the user's information along with the status of his/her reward points. The user may check the amount of previous points collected, points collected in current activity, and the total points to date. The user may then continue with step 22.

Users who choose not to register, or registered users who fail to log in, may visit the site by entering directly to step 22—navigating the webpage, but the user may not earn points associated with their website activities.

In step 20, the user may register by creating an account. To create the account, the user may enter his/her email address; choose a username, and password. In step 20, the user may be advised about the rules and advantages of tallying the highest number of point values 11 during a time period according to the method 10. The user may then continue with step 22. The time period may be, for example, a week, two weeks, or a month.

In step 22, the user may navigate pages of the different webpage links 13 on the website 14, while tallying point values 11. As the user may proceed to navigate the webpage links 13, software may monitor and summarize the user's activities and tallied points. The software may be a commercially available software module that may allow ascribing and summing point values to each registered user based on their activities on the website 14.

The total point value 11 earned during the each section may be added to the total points of previous sessions. The user may observe the total points earned by looking at the homepage of the website 14.

The point values 11 may depend on the type of activity performed during the visit to the website links 13. The activity may be selected from registrations, reading articles, clicking on advertisement banners, participating in discussion forums, surveys, polls, answering trivia questions, reviewing products, commenting on online content, or uploading media such as music, pictures, and videos. The number of point values 11 earned on each activity may be determined by the website. The website may include, next to each webpage link 13, the amount of point values 11 that may be earn on each activity.

The user may not obtain additional point values 11 for activities previously performed within a time period. However, participating in discussion forums, product reviews, blogs, and comments directed to the content of the website, if different from original participation, may be rewarded as often as those comments/participations occur.

The user may obtain the number of tallied point values 11 during a time period. The reward may be promotional gifts, prizes, discount coupons, or air travel mileages. Registered users achieving the highest number of points over a given time period may be eligible to receive rewards. Winners may be notified via email and their identity may be disclosed on the website, if the user grants permission.

The method 10 may be used in restaurants, supermarkets, travel industries, or online shopping.

Furthermore, the method 10 may enable publishers to direct users to engage in activities (discussions, opinions, reviews), that otherwise would not necessarily be perceived as “valuable”.

The user may also earn point values 11 engaging in social activities.

The method 10 may stimulate existing users to visit the website more often and stay longer, enhancing the marketability of the website to advertisers. In addition, the method 10 may attract new users to the website.

The method 10 may facilitate dynamic reassessment and change to the point values 11. Specifically, if the feature may ascribe relatively high point values 11 and may be poorly received by the users, the point values 11 may be adjusted accordingly. In addition, if a feature having a low point values 11, but may be visited frequently by users, may allow the point value 11 to be adjusted accordingly.

In the step 24, the registered users may leave the website either by retaining their login status or by logging out. If the user remains logged in, upon revisiting website, he/she may continually earn points for additional activities.

However, depiction of points for activities associated with the lowest point value, including but not limited to low importance articles, visiting customer service, frequently asked questions, and “About Us” pages could be omitted in order to avoid repetition.

The point values 11 may be replaced by a standard reward system. In some embodiments, the point values 11 may be replaced with an asterisk (*, **, ***, . . . *****) or stars.

In some embodiments, the user may be provided with the information about the point system information prior to the step of registering 20.

If the user temporarily leaves the website, the user may not have to log in again.

In some embodiments, a new user may obtain information about the method 10 prior to the step 16 of registering.

It should be understood, of course, that the foregoing relates to exemplary embodiments of the invention and that modifications may be made without departing from the spirit and scope of the invention as set forth in the following claims.

What is claimed is:

1. A method for monitoring and rewarding a website activity, the method comprising the steps of:
creating a plurality of webpage links on the website;
allocating a point value to each webpage link; and
tallying point values by navigating through at least one of the webpage links, wherein the tallying point values are controlled by a computer-readable program.

2. The method according to claim 1, further including the step of issuing a reward based on the tallied point values.

3. The method according to claim 1, wherein the point values are tallied during a given period.

4. The method according to claim 1, further including the step of storing the tallied point values.

5. The method according to claim 1, wherein the webpage link includes activities selected from registrations, reading articles, advertisement banners, discussion forums, surveys, polls, trivia questions, reviewing products, commenting on online content, uploading music, uploading pictures, or uploading videos.

6. The method according to claim 1, wherein the webpage link includes social activities.

7. The method according to claim 2, wherein the reward includes at least one of promotional gifts, prizes, discount coupons, or air travel mileages.
